(19) United States
(12) Patent Application Publication
(10) Pub. No.: US 2011/0286492 A1
(43) Pub. Date: Nov. 24, 2011

(54) SENSOR, AND METHOD FOR CONTINUOUSLY MEASURING THE FOULING LEVEL

(75) Inventors: Laurent Auret, Nailloux (FR); Camille Gispert, Toulouse (FR); Luc Fillaudeau, Castanet-Tolosan (FR); Pascal Debreyne, Fretin (FR)

(73) Assignee: NEOSENS, Labege (FR)

(21) Appl. No.: 13/143,799

(22) PCT Filed: Jan. 11, 2010
(86) PCT No.: PCT/FR2010/050033

§ 371 Date: Jul. 8, 2011

(30) Foreign Application Priority Data
Jan. 9, 2009 (FR) 0950112

(51) Int. Cl. G01K 15/00

(52) U.S. Cl. 374/1; 374/E15.001

(57) ABSTRACT

A sensor (10; 34) for measuring and/or detecting a fouling that forms on one surface of the sensor, includes the following: —a substrate (22) that is used for heat insulation, —at least one heating element (16; 36; 58; 78) arranged on one side on the substrate that is able to diffuse, on command, a homogenous, monitored heat flow from the side opposite the substrate, —a single temperature measuring element (18; 38; 56; 80) with dimensions that are smaller than those of the at least one heating element and positioned above and at the center of the latter, on the side opposite the substrate, in order to be in the most homogeneous part of the heat flow.

The invention relates to a sensor for measuring or detecting the fouling of a reactor or a pipe containing a fluid.

On industrial sites, there are different types of installations in which fluids of various types circulate.

These installations comprise pipes in which fluids circulate and can likewise comprise reactors such as, for example, heat exchangers.

In this exact case, the fouling of these installations can have adverse effects to the degree it is capable of affecting the performance of the installation (for example, the yield of an industrial process).

Moreover, when fouling forms on the inner wall of a pipe or a reactor, it should be promptly cleaned.

However, it is necessary that this fouling be continuously detectable by the operators or the maintenance personnel of the installation in order to be able to assess, within the framework of preventive maintenance, the best time for cleaning.

For whatever reason, the fouling irregularly causes a shutdown of the installation during a sometimes indeterminate interval; this has serious adverse effects on the progression of the industrial process.

These interventions can represent tedious tasks for personnel, the more so if the fouling has only been detected belatedly and if its thickness is too great.

The removal of fouling has a not inconsiderable economic cost since the costs of a temporary shutdown of operations should be included in the cost of maintenance operations.

It should likewise be noted that as the heat exchangers become fouled, there is a progressive loss of efficiency before a potential shutdown of operations of the installation or the part of the installation comprising these exchangers.

Moreover, in hot water sanitation networks and in open industrial air-cooled towers, bacteria can develop within the network and the cooling circuit.

Likewise, a risk of contamination by Legionnaire's Disease can be envisioned.

Currently, there should be regular monitoring of the installations to anticipate points of attack in the pipes or in the reactors in which the fluids that can cause fouling are circulating.

These points of attack likewise make it possible to take samples and then to analyze them in a laboratory to obtain either a measurement of fouling or an analysis of the type of fouling that has formed (nature, composition . . . ).

On certain industrial sites, to measure the thickness of the layer of fouling that has formed within the walls of a pipe or a reactor, methods are used that require measurement of the loss of load that occurs between two separate points in the direction of fluid flow. It is also possible to use methods that measure the temperature differences between these points.

These latter measurements, however, present genuine problems to the degree in which:
They do not allow local information to be obtained,
They lack reactivity, but likewise sensitivity and extent of the measurement range.

Document FR 2 885 694 discloses a method of measuring the fouling in a reactor or a pipe that uses two temperature probes.

More particularly, these two probes are introduced into the pipe respectively due to two points of attack, and one of these probes measures the temperature of the fluid while the other probe measures the temperature of the wall of a heat generator.

According to this method, the point is first of all to obtain a temperature difference between the wall temperature and the fluid temperature that is as near zero as possible. Then, the heat generator emits a heat flow while the temperature deviation between the wall temperature and that of the fluid is measured over time, the state of fouling of the reactor being determined based on the measurement of this temperature deviation.

This method and the associated system, however, have certain defects that limit their use in an industrial environment.

In particular, the presence of two points of physical attack on one pipe or a reactor always constitutes an installation constraint for a manufacturer, accompanied by a not inconsiderable cost.

Moreover, two temperature probes, even if they are the same type, always have a certain drift of operation relative to one another due to, for example, variances that arise during their manufacture.

Because of these drifts, the two probes do not have the same behavior relative to one another vis-a-vis the same temperature of the environment into which they are immersed.

Moreover, the temperature probe that is used as the reference (the one that measures the fluid temperature) can itself become fouled; this introduces an additional drift relative to the other temperature probe.

Due likewise to the kinetic (or dynamic) differences of responses between the two temperature probes, a temperature deviation between the two probes can then be affirmed, whereas theoretically such a temperature deviation should not arise.

Then, the method used in the aforementioned document dictates the complete absence of variation of the temperature of the fluid into which the two separated temperature measuring elements are immersed. This is because this significantly reduces the range of applications to the degree in which most industrial processes and/or water treatment processes continuously modify and disturb the average temperature of the environment.

Finally, the method used, by imposing initial conditions, at the same time requires a posteriori processing of the recorded data as well as systematic verification of the conditions before any use. Thus, this makes this method unusable for continuous applications or for a long-term operation (24 h/24). At best, the access to the temperature difference (thermal drift) can be observed over the anticipated and programmed measurement period.

The defects that were just cited can thus lead to faulty measurements of fouling and thus to a lack of reliability of the method used. Moreover, as a result of the operating mode and constituent elements of the physical device, the number of possible applications is limited.

It would thus be advantageous to be able to have a system for determination of fouling with a simplified design that provides reliable measurements over time.

Thus, the object of this invention is a sensor for measuring and/or detecting a fouling that forms on one surface of the sensor, characterized in that it comprises the following:
A substrate that is used for heat insulation,
At least one heating element located on one side on the substrate that is able to diffuse, on command, a homogenous, monitored heat flow from the side opposite the substrate,
A single temperature measuring element with dimensions that are smaller than those of said at least one heating element and that are positioned above and at the center of the latter, on the side opposite the substrate in order to be in the most homogeneous part of the heat flow.

The temperature measuring element has dimensions that are small enough relative to those of the heating element so that when it is positioned superimposed at the center of the heating element, it is in the part of the heat flow that is as homogenous as possible (heart of the flow) and as far as possible from the sides of the heating element in order to be able to avoid edge effects. Thus, the known physical formulas linking the thickness of a fouling layer to the temperature deviation caused by this layer for different sensor configurations (planar or cylindrical configuration) can be applied.

It should be noted that the heat insulating substrate channels the heat flow generated by the heating element or elements in one direction that is away from the substrate. The diffused flow is thus channeled toward the temperature measuring element.

Heat transfer is thus optimized in the same manner as the operating efficiency of the sensor.

Taking into account the specific arrangement of the sensor, the surface temperature measured by the latter is very reliable and is obtained very quickly, the temperature measuring element is directly in contact with the measurement medium (fluid) or indirectly via a protective interface. The measurement of temperature is local and not global due to the small dimensions of the measuring element.

It should be noted that such a sensor offers a greater reactivity when the temperature measuring element is directly in contact with the fluid since there is no heat resistance due to the interface between the temperature measuring element and the fluid.

The sensor is thus faster and more sensitive than in the presence of the interface.

Moreover, this sensor can operate even when the fluid is at rest, taking into account the increased sensitivity of the sensor.

Moreover, the heating element or elements, for example flat, dissipate a very weak heat output in order not to heat the fluid because this would risk disturbing the temperature measurements that would then be less representative of the fouling phenomenon itself.

However, the heat output must be great enough that the temperature measuring element can deliver a useful signal.

It should be noted that this sensor works with a single temperature measuring element.

Moreover, the sensor according to the invention can deliver measurements continuously and in real time, regardless of the development of the conditions of the measurement medium (uncontrolled fluid temperature).

According to one characteristic, the temperature measuring element is miniaturized relative to said at least one heating element.

This miniaturization ensures measurement precision and sensor reactivity.

According to one characteristic, the temperature measuring element has a surface whose size is at least essentially less than 100 times that of the surface of said at least one heating element.

This ratio of relative dimensions ensures reliability, sensitivity and reactivity of the sensor. The surface ratio can be less than 1%.

It should be noted that the size of the surface that matters in the heating element is that of the active zone (heating zone) and not the total size including that of the inactive zone (no-heating zone, for example peripheral zone).

According to one characteristic, said at least one heating element is able to generate a heat output density of between 1 and 4 mW/mm².

As already briefly elucidated, such a heat output allows generation of a heat flow sufficient to be detected by the temperature measuring element (and so that it can locally measure the temperature of the site at which it is located) without, however, being too high so as not to disturb the fluid.

According to one characteristic, the sensor comprises at least one heat conductive interface element with two opposite surfaces, one of the surfaces, i.e., the inner surface, being located against the temperature measuring element. The other surface, i.e., the outer surface, is designed to be in contact with the measurement fluid medium.

Such an interface element protects the temperature measuring element as well as the remainder of the sensor and is chosen (material and thickness) so as to offer as little heat resistance as possible.

By adapting said at least one interface element, or at least its outer surface, depending on the environment in which the sensor is to be placed, it is ensured that the latter will behave like an element that is part of this environment and not as a foreign body.

In particular, by reproducing at least on the outer surface of the interface element the state of the surface of the wall of the container in which this sensor is designed to be installed, the formation of possible fouling on this outer surface will be very highly representative of the phenomenon of fouling on the wall of the container.

Thus, the state of the outer surface of the interface element depends on the state of the inner surface of the wall or walls of the container, state of the surface that depends on the anticipated applications.

By way of example, the interface element can be made of stainless steel, for example of class 316L, if the fluid is circulating in a pipe of stainless steel 316L or even of polyvinyl chloride (PVC) if the fluid is circulating in a PVC pipe.

A sensor or at least the interface element of a sensor is thus dedicated to a given application, and, at least, a given situation.

Moreover, the presence of this interface element in contact with the fluid, flowing or not, protects the sensor, at least mechanically, or equally chemically, and makes it resistant to external attacks, especially originating from the fluid.

According to one characteristic, at least the outer surface of said at least one interface element is made of a material of the same nature (for example identical) as that of the wall of the container that is in contact with the fluid.

According to one characteristic, the outer surface of said at least one interface element has a roughness that is equivalent (for example identical) to that of the wall of the container that is in contact with the fluid.

This adaptation makes it possible to refine the similarity between the interface element and at least its outer surface, and the wall of the container.

According to one characteristic, said at least one interface element has (between its two opposing surfaces) a heat resistance that is less than or equal to 4° C./W.

This characteristic of the interface element makes it possible to ensure that the heat flow generated will be effectively diffused as far as the outer surface and will be evacuated by the fluid without encountering strong heat resistance that would risk causing a temperature increase that is harmful to proper operation of the sensor. Moreover, this makes the sensor more sensitive, more reactive and more reliable.

It should be noted that the thickness of the material of the interface is thus adapted depending on the material itself, taking into account the heat resistance not to be exceeded.

According to one characteristic, the sensor has a general elongated shape in a longitudinal direction, with said at least one heating element, the temperature measuring element and said at least one interface element when it is present being aligned behind one another in the longitudinal direction of the sensor.

In this configuration, the sensor is designed to be mounted flush in the wall of the container, in contact with the fluid. Arranged in this way, it does not disturb the fluid and thus the flow when the fluid is flowing.

According to one characteristic, the sensor has a general elongated shape in a longitudinal direction, with said at least one heating element, the temperature measuring element, and said at least one interface element when it is present being aligned behind one another in a direction that is perpendicular to the longitudinal direction of the sensor.

In this configuration, the sensor is designed to be mounted projecting into the fluid, for example from the wall of the container in contact with the fluid.

It should be noted that the means for delivering energy to the different operating elements of the sensor and means for processing the data supplied by these elements are attached to the sensor to allow it to perform its measurement and/or detection function. Additional means for displaying results (curves of temperature, of fouling . . . ) and/or means for remote transmission of these results and/or qualitative information (presence or absence of a fouling layer . . . ) can be provided.

The invention calls for using the sensor briefly described above to measure or detect the fouling that has formed (or is forming) on the sensor that is installed in one wall of a container (example: industrial piping or industrial reactor) enclosing a fluid.

More generally, the fouling forms on the outer surface of the sensor that is exposed to the fluid.

This surface is either the surface of said at least one heating element bearing the temperature measuring element in the absence of the interface, or the outer surface of said at least one interface element.

Thus, the sensor measures the local wall temperature and determines the temperature deviation when a weak electrical power is applied to said at least one heating element.

Based on this temperature deviation, the thickness of the fouling that is forming naturally (i.e., not induced, for example, by heating the fluid) on the outer surface of the sensor is determined continuously and in real time (no comparison with prerecorded reference measurements is necessary).

The envisioned process thus allows, based on a single temperature measuring element, when the prior art required two measuring elements, determination of the fouling formed on the outer surface of the sensor more reliably than in the prior art.

More particularly, the process allows local measurement of the thickness of the fouling that is representative of a significant temperature deviation or, according to the applications, detection (by way of indication) that fouling is being formed (monitoring and alarm function).

The object of the invention is a system for measurement or detection of fouling formed on one surface of the sensor that is exposed to a fluid, comprising the following:
Means for determining a temperature deviation between, on the one hand, the wall temperature measured by the temperature measuring element when said at least one heating element is diffusing a heat flow, and, on the other hand, the temperature of the fluid,
Means for calculating the thickness of the fouling formed on the surface of the sensor exposed to the fluid based on the determined temperature deviation.

The object of the invention is likewise a process for measuring or detecting the fouling formed on the sensor briefly described above when the latter has been installed in the wall of the aforementioned container.

Thus, the object of the invention is a process that comprises the following stages:
Determining a temperature deviation between, on the one hand, the wall temperature measured by the temperature measuring element when said at least one heating element is diffusing a heat flow and, on the other hand, the temperature of the fluid,
Calculating the thickness of the fouling formed on the surface of the sensor exposed to the fluid based on the determined temperature deviation.

More particularly, the object of the invention is a process in which the determination of a temperature deviation comprises the following stages:
Alternation of the phases of control of the diffusion of a heat output by said at least one heating element and of the non-diffusion of a heat output,
Permanent measurement of the wall temperature by the temperature measuring element during each of the aforementioned phases,
Determination of a temperature deviation between the temperatures measured by the temperature measuring element.

Thus, the measurement or detection of fouling is done by determining the temperature deviation provided by the wall temperature measuring element when said at least one heating element generates a heat flow and when it does not.

It should be noted that when a heat flow is not generated, the sensor that is especially sensitive and reactive measures the fluid temperature.

However, other methods can be envisioned for knowing the temperature of the fluid (for example, this temperature can be constant due to the industrial process).

By way of example, in the absence of fouling on the outer surface of the sensor exposed to the fluid, the temperature deviation is less than 0.1° C., while it can reach 2 to 3° C. in the presence of serious fouling.

According to one characteristic, said at least one heating element is controlled to diffuse a heat output density of between 1 and 4 mW/mm².

This limited output acquires the same advantages as those described above.

According to one characteristic, the stage for control of diffusion of a heat flow by said at least one heating element comprises a stage for generation of an output modulation signal from said at least one element.

According to one characteristic, the signal is alternating.

According to one characteristic, the alternating signal is steady-state.

According to one characteristic, the steady-state alternating signal is in square waves.

Other characteristics will become apparent during the description below, provided solely by way of nonlimiting example and with reference to the accompanying drawings, in which:

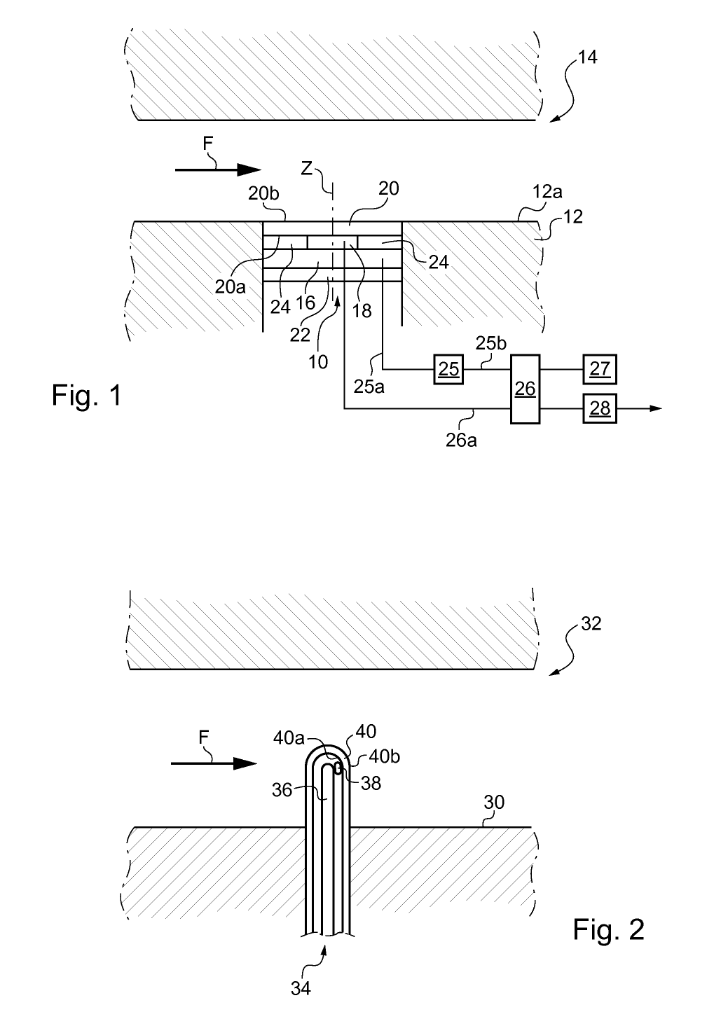

FIG. 1a is a general schematic view of a sensor according to a first embodiment of the invention;

FIG. 1b is a general schematic view of a sensor according to a variant embodiment;

FIG. 2 is a general schematic view of a sensor according to a second embodiment of the invention;

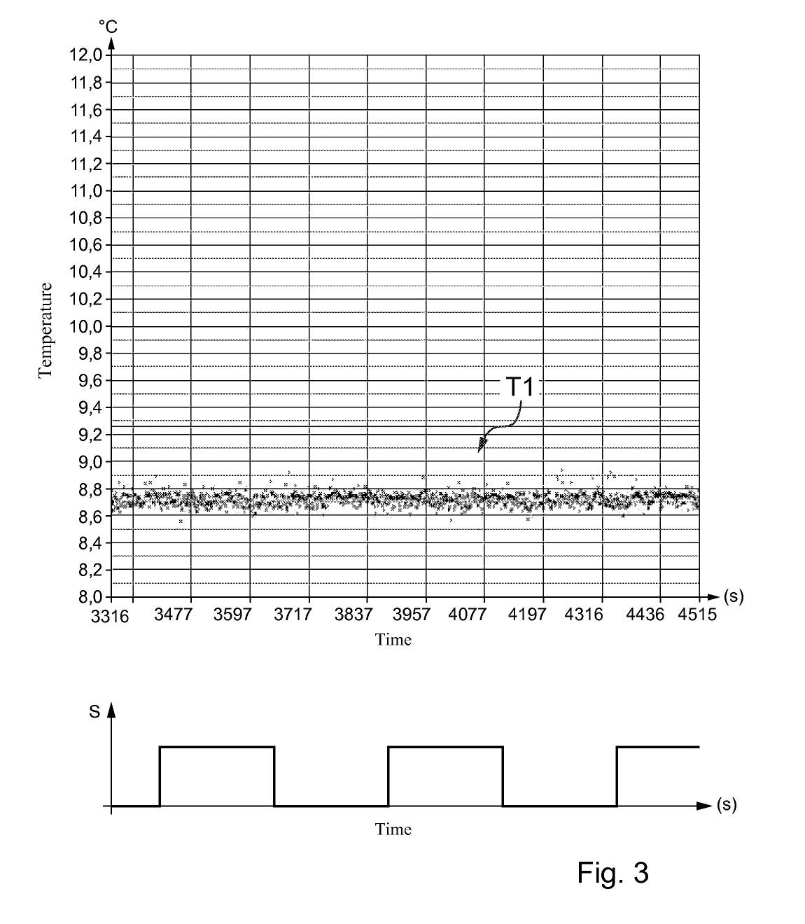

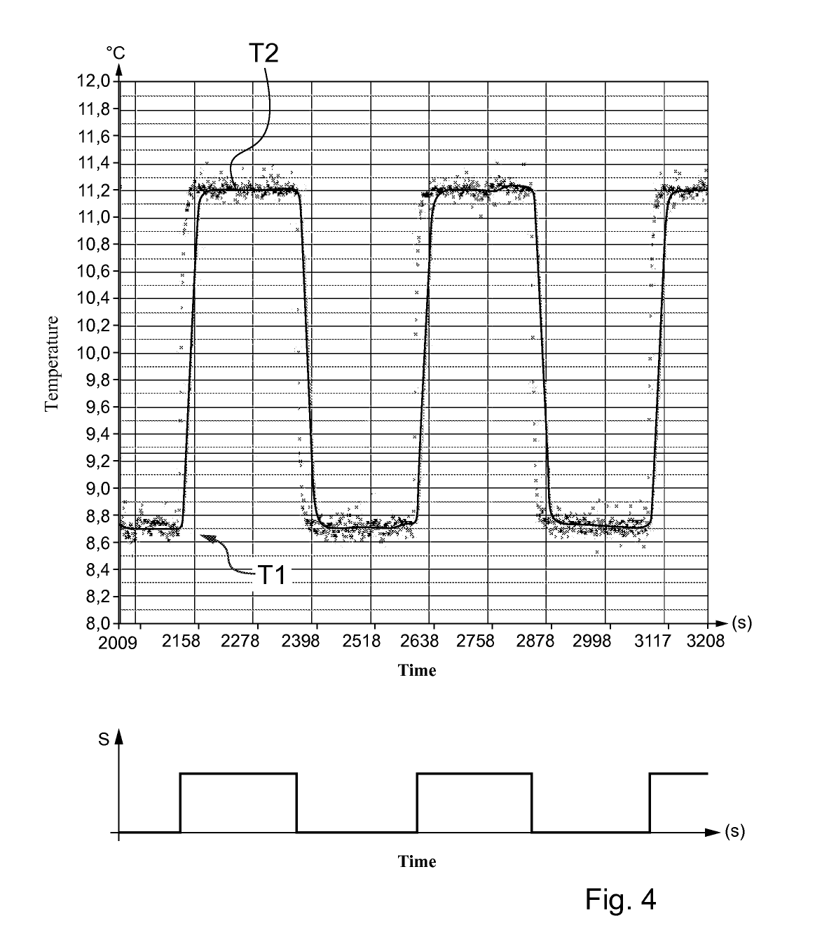

FIGS. 3 and 4 illustrate temperature measurements taken by a sensor according to the invention, in the presence and absence of fouling relative to a supply signal S, respectively;

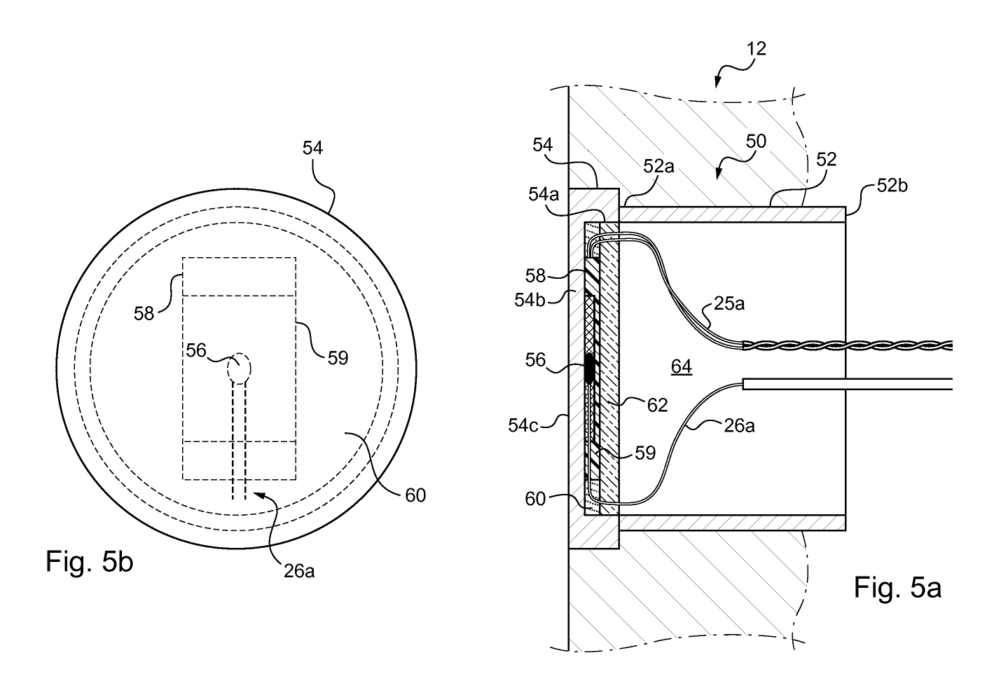

FIGS. 5a and 5b illustrate the sensor 10 of FIG. 1a in greater detail;

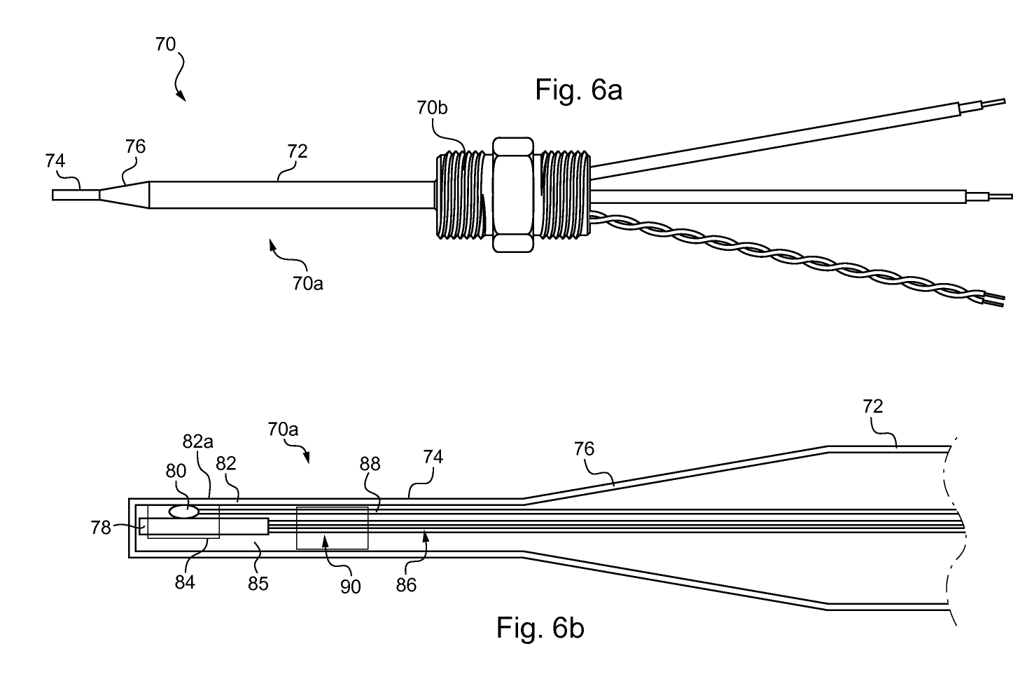

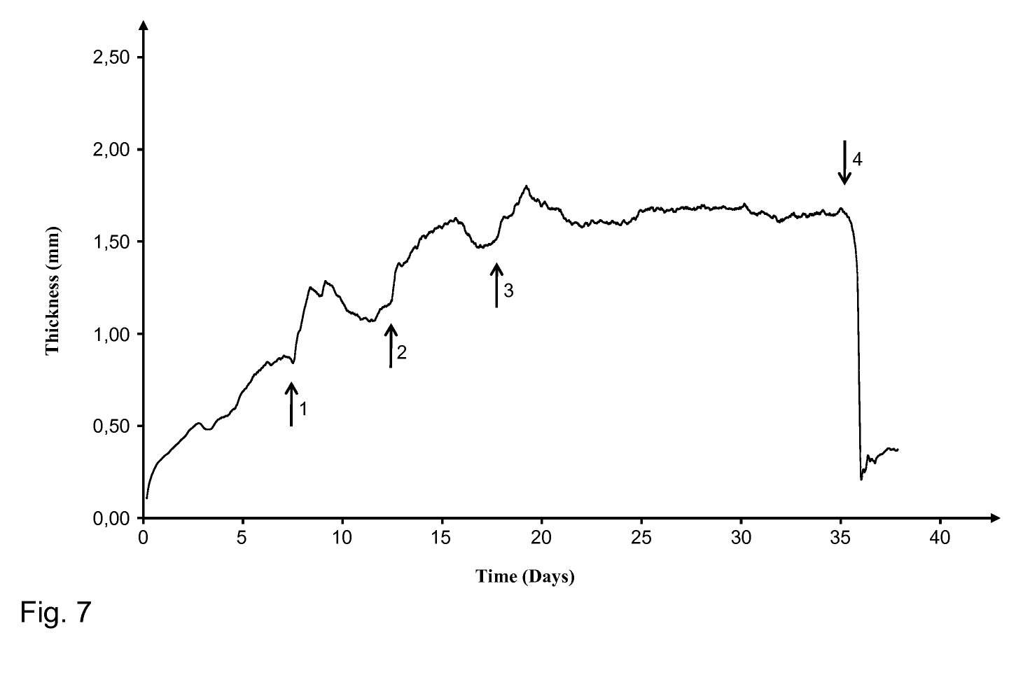

FIGS. 6a and 6b illustrate the sensor 34 of FIG. 2 in greater detail;

FIG. 7 schematically illustrates the development of a fouling curve over time in an industrial cooling reactor.

As shown in FIG. 1a, a sensor 10 is installed in a wall 12 of a container 14 that is, for example, a pipe in which a fluid circulates whose flow is symbolized by the arrow marked by the reference F. This sensor is shown here schematically, and a more detailed example will be described below.

It should be noted that the container 14 containing a fluid can be of a type other than a pipe, and, for example, can be a chemical reactor, and even a container of another type, such as a vat . . . .

It should be noted, moreover, that the fluid present in the container is not necessarily flowing and may be stagnant.

The sensor 10 is mounted in one of the walls of the container, to be flush with the inner surface 12a of the latter, and it comprises several operating elements that will be described below.

The sensor 10 more particularly comprises one or more heating elements, of which only one, 16, is shown here.

This or these heating elements are able to diffuse a controlled homogeneous heat flow when they are controlled in a suitable manner by means that are not shown in this figure, but that will be described below.

The sensor likewise comprises a temperature measuring element 18, placed above the heating element 16 in FIG. 1a, for example against the upper surface of the latter, in order to be located in the homogenous heat flow diffused by it.

The temperature measuring element 18 is positioned at the center of the heating element 16 so as to be at the heart of the most homogeneous part of the heat flow.

This temperature measuring element 18 is in a surface ratio of at least 1 to 100 with the heating element 16 (more exactly with the active zone of the heating element); i.e., the size of the element 18 is at least 100 times smaller than that of the element 16.

FIG. 1a does not reproduce these relative proportions for reasons of scale and readability.

The miniaturized temperature measuring element 18 is thus placed in a homogenous heat flow generated by the heating element.

The density of the generated heat output is between 1 and 4 mW/mm²; this is sufficient for the measuring element 18 to be able to measure a temperature and weak enough not to influence the measurement (fluid) medium.

Actually, it is necessary to avoid heating the medium in order to avoid, for example, inducing unnatural fouling on the sensor.

It should be noted that the sensor according to the invention comprises only a single temperature measuring element.

The temperature of the fluid, and more generally of the industrial process that involves the container, is generally not known.

For all that, this has no effect on the process for measurement of detection of fouling formed within the container, as will be seen below.

The process makes it possible to avoid possible variations of this temperature over time.

The sensor, moreover, in this example comprises at least one interface element 20 that is placed above the measuring element 18, for example in contact with the latter, and that is mounted flush relative to the wall 12.

More particularly, the interface element 20 comprises two opposite surfaces 20a, and 20b, 20a being called “inner” and being located against the upper surface of the measuring element 18 and the other 20b, called “outer,” being designed to be in contact with the fluid.

The surfaces 20b and 12a are located on the same side in order to avoid introducing disturbance into the flow.

The interface element 20 is adapted so that its outer surface is representative of the surface state of the wall 12 of the container so that the deposition of a fouling layer on the surface 20b of the sensor is done more or less identically to the deposition of a fouling layer on the inner surface 12a of the wall of the container.

Thus, the determination of the fouling formed on the surface 20b of the sensor, a determination that corresponds either to a measurement of fouling or to a detection of fouling, will be particularly reliable, taking into account the nature of this outer surface 20b.

In order that the outer surface 20b be representative of the state of the surface of the wall of the container, it is preferred that this surface have a roughness that is identical to that of the wall.

Thus, for example, within the framework of an agricultural application, the wall 12 of the pipe can be made of stainless steel, for example stainless steel of class 316L, and the surface 20b of the sensor will be particularly well polished, like the surface 12a of the pipe, in order to achieve values of roughness (Ra) on the order of 0.8 μm.

Preferably, the outer surface 20b is made of a material of the same nature as that of the wall of the container. If this material is not identical, it must be at least of a nature compatible with that of the material comprising the wall.

The simplest approach is that the interface element 20 is made of a material that is identical to that of the container wall.

It should be noted that the interface element has a heat resistance that is less than or equal to 4° C./W in order to impart to the sensor good sensitivity and an increased signal-to-noise ratio.

Taking into account this characterization of the interface element, matched interface material and thickness (dimension between the opposite surfaces 20a and 20b) are selected.

Thus, for example, an interface material of stainless steel 316L of less than 300 μm of thickness can be used.

The sensor 10 can likewise comprise one or more heat insulating elements 22 placed in the back part of the sensor, i.e., on the opposite side from the part where the interface element 20 is in contact with the fluid.

This or these heat insulating elements 22 contribute to channeling the heat flow diffused by said at least one heating element 16 toward the measuring element 18 and toward the interface element 20 placed behind the latter.

This or these elements are likewise used as a substrate protecting the sensor.

Moreover, one or more heat insulating elements can be arranged around the sensor, between the latter and the wall of the container in which it is installed, in order to better channel the diffused heat flow.

It should, moreover, be noted that the sensor 10 comprises, adjacent to the measuring element 18 and interposed between said at least one heating element 16 and the interface element 20, one or more heat conductive elements 24 that enhance transmission of the homogeneous heat flow generated by said at least one heating element 16 for purposes of transmitting it to the interface element 20.

In the example shown in FIG. 1a, the sensor has a cylindrical revolution symmetry and the element 24 has, for example, an annular shape surrounding the measuring element 18.

It should be noted that the sensor 10 has a general elongated shape following a longitudinal direction that corresponds to that of its axis of revolution Z and the aforementioned different operating elements; i.e., the heating element or elements, the measuring element and said at least one interface element are aligned one behind the other (or one above the other) following this direction.

An electronic device 25 is connected to the heating element 16 by connection means 25a, on the one hand, and to a data processing unit or computer 26 (including, for example, a microprocessor and memories) by connection means 25b, on the other hand. The device 25 is designed to supply electrical energy to the heating element. For example, it can be a current generator that is able to inject the necessary electrical power on command.

The processing unit 26 collects the different data originating from the device 25 (power induced in the heating element 16) and from the temperature measurement element 18 (wall temperature detected by this element) via connection means 26a.

This unit 26 samples and converts into physical quantities (temperature, . . . ) the measurements and data originating from the sensor as well as the generated power. It should be noted that the system for determination of fouling that is formed from elements 25, 25a-b, 26 and 26a comprises means (unit 26) for determining a temperature deviation between the temperatures measured by the measuring element and the means for calculating (unit 26) the thickness of the fouling formed on the surface of the sensor based on this temperature deviation that has been determined in this way and physical formulas of the geometry of the known sensor.

More particularly, the means for determination determine a temperature deviation between, on the one hand, the wall temperature measured by the temperature measuring element when the heating element is dissipating a heat flow, and, on the other hand, the fluid temperature. Moreover, the system optionally comprises a display 27 and/or means 28 for remote data transmission. The display 27, for example, allows continuous display of the values of temperature (measured) and fouling (calculated), as will be seen below. The means 28 (example: transmitter) allow remote sending of data measured and/or processed by the unit 26 and/or alarm information and/or other information relative to the sensor and/or to its operating state.

FIG. 1b illustrates one variant embodiment of the sensor shown in FIG. 1a in which the interface element 20 is absent.

All of the particular characteristics and advantages described in relation to the sensor 10 of FIG. 1a, except for those relating to the interface element 20, remain valid here and will not be repeated.

The sensor of FIG. 1b acquires a sensitivity that is greater than that of the sensor of FIG. 1a since the wall temperature measuring element 18 is directly in contact with the fluid and no heat resistance is interposed between the fluid and the measuring element in the absence of fouling.

The surface of the sensor exposed to the fluid in this way is the one bearing the temperature measuring element.

Taking into account this increased sensitivity, the sensor 11 can be advantageously used when the fluid is at rest.

FIG. 2 illustrates another embodiment of the sensor according to the invention and its installation in a wall 30 of a container 32.

The sensor 34 shown in FIG. 2 is mounted to project into the fluid flow marked by the arrow F and thus protrudes relative to the wall 30.

This sensor has a general elongated shape in a longitudinal direction and has, for example, an essentially cylindrical shape, at least in its part that has been placed in the flow.

More particularly, the sensor 34 comprises the same operating elements as those described relative to FIG. 1a, i.e., at least one heating element 36, one temperature measuring element 38 and at least one interface element 40.

The temperature measuring element 38 is placed on the surface of the heating element 36 in the heat flow diffused by the latter.

The interface element 40 has two opposite surfaces, one surface 40a, called the inner surface, and one opposite surface 40b, called the outer surface.

The inner surface is in contact with the measuring element 38 while the outer surface is in contact with the fluid.

As for the surface 20b of the sensor 10 from FIG. 1a, the outer surface 40b is representative of the state of the surface of the wall 30 of the container for the same reasons.

For the sake of simplicity, the interface element 40 is made of a material of the same nature as that of the wall 30, and even is identical to the latter.

The characteristics described for the sensor 10 from FIG. 1a can likewise be used again for the sensor 34, especially in terms of roughness of the outer surface of the interface element, the thickness of this interface element relative to the heat output generated by the heating element, as well as the channeling of the heat flow by one or more heat insulating elements that are not shown in FIG. 2.

The same operating elements 25, 25a-b, 26 and 26a, 27 and 28 that are shown in FIG. 1a can likewise be adopted here to allow the sensor 34 to operate.

The process according to a first embodiment of the invention will now be described with reference to FIGS. 3 and 4.

This process allows measurement and/or detection of the fouling that forms on the outer surface of the interface element of the sensor (surface 20b of the sensor 10, the surface bearing the measuring element 18 of the sensor 11 and surface 40b of the sensor 34).

“Fouling” is defined as any adhering deposit that forms on the surface of the element under consideration from bodies that are temporarily or permanently in the fluid (fouling of an organic nature, such as a biofilm, or inorganic, such as scaling).

It should be noted that the process according to the invention allows measurement and/or detection of fouling on site, in line or continuously, and more or less in real time.

Thus, it is not necessary to take samples on site and later to analyze the samples taken for purposes of measurement and/or detection of fouling.

The process according to a first embodiment of the invention calls for alternating the phases for control of diffusion of a heat flow by the heating element or elements of the sensor and of the non-diffusion of a heat flow over a given time interval.

Moreover, the process during this interval calls for continuous measurement of the surface temperature of the interface element in contact with the measurement medium using the element for measuring the temperature (or only the local temperature of the site where the temperature measuring element is positioned in the absence of the interface element).

For example, this alternation of phases of heating and no-heating of the sensor throughout the progression of an industrial process or only during certain of its stages can be carried out.

The operation of measuring the fouling allows knowledge, at any time, of the thickness of the layer of fouling that has formed on the surface of the sensor and very reliably reproduces the fouling that has formed on the inner surface of the container in which the sensor is installed.

Moreover, when the sensor is used to perform a detection function, it can be used to deliver an alarm signal in case of detection of a layer of fouling in the course of formation.

As already described above, the device 25 generates an electrical output that is transmitted to the heating element, for example in the form of an output modulation signal that is, for example, of the alternating type.

This signal is preferably steady-state; i.e., it defines perfectly determined stable states during which either a defined electrical output is supplied to the heating element, or no output is supplied to this element.

FIG. 3 illustrates an alternating steady-state signal made in the form of square waves.

More particularly, FIG. 3 illustrates, on the one hand, in the lower part, the output signal in the form of square waves S that is applied to the heating element, and, on the other hand, in the upper part the temperature measured by the measuring element during each of the phases of heating and no heating.

The different measurements of temperature show that they remain essentially constant (around a value T₁); this reflects an unfouled state of the sensor and thus of the inner wall of the container.

The temperature T₁ corresponds to the temperature of the fluid medium.

The medium in which these measurements are taken is an agitated medium since the fluid is flowing; this allows the released heat to be dissipated to the outer surface of the interface element by a convection phenomenon.

When the surface state is clean, the heat flow produced by the heating element is transferred to the measuring element and to the interface element, and then it is diffused into the measurement medium, and the temperature measured by the measuring element remains, in certain cases, constant and equal to the temperature of the medium. If not, in the other cases, if the interface element is generating a barrier to the heat diffusion and/or if the agitation of the medium is insufficient, a temperature difference appears. This temperature difference will then be taken into account in the calculations for determining the fouling value.

When a fouling is forming on the outer surface of the sensor and thus on the inner surface of the wall of the container, the heat flow generated by the heating element will cause an increase of the temperature at the level of the interface element. Actually, the fouling layer in the course of formation acts as heat insulation that thus reduces heat exchanges with the measurement medium and thus the dissipation of the flow.

This phenomenon is depicted in FIG. 4 by the appearance of levels of temperature increase corresponding to parts of the square wave signal S in which power is injected into the heating element.

The temperature deviation between the temperature measured at the level (T₂) and the temperature measured in the absence of fouling (T₁) is representative of the fouling formed at the instant corresponding to the measurements that have been taken and more particularly of the thickness of the fouling layer.

This thickness is obtained by formulas that are well known to one skilled in the art and that depend on the geometric configuration of the sensor, namely a flat geometry for the sensor 10 of FIG. 1a, the sensor 11 of FIG. 1b, or a cylindrical geometry for the sensor 34 of FIG. 2.

More generally, the thickness of the fouling layer is provided by the following equation for the configuration such as is shown in FIG. 1a and FIG. 1b:

$$\frac{P}{ π \cdot h ( r + e )} + \frac{P}{2 \cdot π \cdot L \cdot λ} \cdot ln ( 1 + \frac{e}{r} ) + {T}_{1} - {T}_{2} = 0$$

and by the following formula for the configuration such as is shown in FIG. 2:

$$\frac{P}{2 \cdot {D}^{2} \cdot h} + \frac{P \cdot e}{2 \cdot λ} + {T}_{1} - {T}_{2} = 0$$

where:

P, in W, designates the electrical power supplied to the heating element,

h, in W/m²/K, designates the coefficient of convective heat transfer,

T1 and T2, in K, designate the measured temperature in the no-heating phase and the measured temperature in the heating phase, respectively.

L, r, D, in m, designate the geometric parameters of the heating element that is used (L for length, r for radius, D for diameter).

λ designates, in W/m/K, the coefficient of thermal conductivity of the fouling layer being deposited on the surface of the sensor,

and finally, e designates, in m, the thickness of the fouling layer that is being deposited on the surface of the sensor.

It should be noted that the more the thickness of the deposit formed on the sensor surface increases, the more the temperature rise will be significant for a given power.

In practice, the process calls for imposing a set heat value in output (example: 100 mW) by applying an electrical current whose intensity can vary from 5 to 100 mA, for determining the temperature deviation that results therefrom (increase), and then calculating the thickness of the fouling layer.

It should be noted that current compensation can be implemented depending on possible variations of the fluid temperature.

It should be noted that the length of the heating period varies from several seconds to several minutes, as shown in FIGS. 3 and 4, and that the elapsed time is expressed in seconds.

The length of the heating period is not necessarily equal to the length of no heating; for practical reasons of implementing the invention, equal time intervals of heating and no heating will be preferred. Moreover, the length of the period of heating and/or no heating can vary over time in order to dynamically adapt to the operating conditions of the industrial process, but in practice, an optimum length will be determined, set and maintained according to the application and the industrial process.

From a practical standpoint, the temperature deviation T2−T1 is determined by using linear and/or nonlinear regression algorithms between two periods of no heating that surround a period of heating.

It should be noted that an upper limit of supply power can be provided in the regulation phase so that in case of no fouling, the power necessary to generate the desired temperature deviation does not exceed the physical power limit of the electronic system.

It should be noted that the simple detection of a significant temperature deviation, such as, for example, a deviation of 1 degree Celsius, provides significant information since it is representative of a fouling that has formed within a container containing a fluid.

Such information can, for example, lead to sending an alarm signal to warn an operator or maintenance personnel of the installation.

This detection function can, of course, be linked to the operation for measuring the fouling in order to be able equally to provide quantitative information on the thickness of the fouling layer that has thus formed.

The curves illustrated in FIGS. 3 and 4 have been obtained with a sensor such as the sensor 10 that is shown in FIG. 1a and that will be described in detail in FIGS. 5a and 5b.

The sensor 50 illustrated in FIG. 5a that is designed to be installed in one wall of a container, such as the wall 12 of FIG. 1a, comprises one or more heating elements, a temperature measuring element, and one or more interface elements such as described with reference to FIG. 1a.

More particularly, the sensor 50 is arranged in a cylindrical jacket 52 provided on one of its longitudinal ends 52a with a plate 54 that forms a shoulder and that has the shape of a disk, for example.

The opposite end 52b is itself open to the outside.

It should be noted that other forms can be envisioned without changing the operation of the sensor.

It should be noted that the plate 54 that forms the shoulder is designed to be inserted into an arrangement that has been correspondingly provided in the wall 12 of the container in order to be mounted in a position that is flush relative to the latter.

The inside of this plate 54 forms a cavity 54a in which the different operating elements of the sensor are located.

More particularly, a measuring element 56 that is, for example, a thermocouple of type K, is located between, on the one hand, a wall 54b of the plate 54 that acts as the interface element, and on the other hand, a heating element 58 that, for example, comes in the form of a resistive element of type PT100 that is, for example, arranged on a ceramic substrate.

More particularly, the wall temperature measuring element is a thermocouple of type K (class A/B with an insulated hot weld that is coated with a metal sheath) whose diameter is between 0.25 mm and 0.50 mm.

A measuring element of this type is, for example, marketed by the company OMEGA under reference KMTSS-IMO25U-200, and it is a thermocouple of type K whose diameter is equal to 0.25 mm.

Another temperature measuring element example is provided by the company CIM under the reference K1050070I1000N (thermocouple K of class 1 of Inconel and of diameter 0.5 mm).

As for the heating element, it is more particularly a platinum film deposited on a ceramic element or a platinum wire surrounded by a ceramic element.

The length of the heating element varies from 1 mm to 50 mm, its width from 1 mm to 50 mm, and its thickness from 0.5 mm to 5 mm.

One example of the heating element is provided by the company PYRO CONTROLE under the reference L062300-000.

The heating element in question has a size of 1 cm×1 cm and the active zone (heating zone) of this element has a size of 7 mm×7 mm.

Thus, when this heating element and the temperature measuring element provided by the OMEGA Company are used, the surface ratio between the two elements is 245; this indicates that the temperature measuring element is 245 times smaller than the active zone of the heating element.

The temperature measuring element 56 is at the same time in contact with the heating element 58 and the inner surface of the interface element 54b that in turn is in contact with the fluid by its outer surface 54c.

The measuring element 56 is surrounded by a material 59 that ensures good heat transfer between the heating element 58 and the interface element 54b.

This material is, for example, composed of a paste of high thermal conductivity that is, for example, approximately on the order of 3 W/mK.

It should be noted that the heating element 58 is not arranged flat, but in a longitudinal cutaway in FIG. 5a has a greater thickness on one of its ends in order to be at the same time in contact with the measuring element and with the interface element.

This excess thickness of the heating element allows good positioning of the measuring element between the heating element and the interface element.

The sensor, moreover, comprises an element 60 that ensures the heat insulating function and that comes in the form of a material coating the heating element 58 as illustrated in FIG. 5b.

It is, for example, a paste that is used for heat insulation.

Moreover, the sensor comprises another heat insulating substrate element 62 made, for example, in the form of a Teflon disk, for example 2 mm thick, arranged against the heating element 58 in order to close the cavity 54a and position the set of elements 54, 56, and 58 against the interface element.

It should be noted that the material constituting the plate 54 is, for example, a stainless steel and, for example, stainless steel 316L.

Different mounting techniques can be used to ensure tightness between the sensor 50 and the wall 12, such as, for example, the use of an O ring or a standard industrial fitting such as the ½″ fitting GAZ.

The temperature measuring element 56 and the heating element 58 are connected to the processing unit 26 (FIG. 1a) and to the device 25 respectively via connection means 26a and 25a.

The other components of the measurement system, namely the processing unit of the electrical device 25, the display 27 and possible transmission means 28, are not shown in FIGS. 5a and 5b, for the sake of clarity, but they are identical to those described in relation to FIG. 1a.

The device 25 is typically a current generator, of which the current set value can be fixed that will be imposed according to a time cycle defined and/or programmed by the processing unit 26.

Moreover, a filling material 64 such as a resin, for example, of the epoxy type with good temperature behavior of between −70° C. and +250° C., fills the cylindrical housing that is internal to the jacket 52, thus allowing the connection means 26a and 25a as well as the different components located in the front part of the sensor, more particularly in the cavity arranged in the plate 54, to be kept in position.

FIGS. 6a and 6b illustrate another detailed embodiment of a sensor 70 according to the invention that adopts the structure of the sensor 34 of FIG. 2.

As shown in FIG. 6a, the sensor 70 has a general elongated external shape according to which the different components necessary to the operation of the sensor are arranged, namely one or more heating elements, a measuring element, and at least one interface element in contact with the fluid.

More particularly, the sensor 70 has a first part, called front part 70a, that is designed to be placed in the fluid that is present in the container 32 of FIG. 2, and a second part, called rear part 70b, which comprises means for attaching the sensor to the wall 30 of the container.

This rear part 70b has, for example, threading on its outer surface, making it possible to work with a corresponding threaded hole made in the thickness of the wall 30.

The front part 70a, thinner than the rear part, comprises sensing elements.

More particularly, the front part comprises two parts of different thicknesses 72 and 74 that are separated from one another by an intermediate portion 76 that forms a constriction.

FIG. 6b is an enlarged view of the front part 70a of the sensor and shows in a longitudinal cutaway the different components arranged in the latter.

Thus, the sensing components are more particularly arranged within the portion, for example the cylindrical one 74, of smaller diameter.

The small diameter of this end portion (for example 3 mm) is chosen to introduce as few disturbances as possible into the medium in which the temperature measurements are going to be taken, and, likewise, to ensure the best heat diffusion of the heating element 78 to the circulating fluid.

The heating element 78 is arranged inside the end portion 74 in the terminal part of the latter, and the temperature measuring element 80 is placed in contact with this heating element and with the wall of the cylindrical sheath that forms the interface element 82 in contact with the fluid by its outer surface 82a.

The different elements 78, 80 and 82 are thus arranged against one another in such a way as to optimize the heat transfer from one to another.

For example, the heating element 78 is a coil resistance element of type PT100 that is placed in a ceramic jacket.

The temperature measuring element 80 is, for example, a thermocouple of type K, whose hot weld is placed at the center of the element.

More particularly, the heating element 78 is made in the form of a wire wound under a glass tube or under a ceramic tube whose diameter is between 0.5 mm and 3 mm and whose length is between 5 mm and 30 mm.

One example of a heating element is, for example, provided by the company CIM under reference 0309/3145-1, and it has a diameter of 5 mm and a length of 25 mm.

The temperature measuring element 80 may be identical to that chosen in the sensor shown in FIGS. 5a and 5b.

An adhesive 84, for example, of Kapton, makes it possible to keep the heating element in position essentially at the center of the cylindrical portion 74 and in contact with the measuring element, and is itself in contact with the wall 82.

A material 85 that enhances the diffusion of the heat flow generated by the heating element fills the end part of the cylindrical portion 74 where the sensing elements are located in order to encase the latter and to enhance diffusion of the heat flow from the center of this part toward the wall 82 depending on the geometry of revolution of the sensor.

This material has high thermal conductivity, for example 3W/mK.

Connection means, for example wire connection means, 86 and 88, connect the heating element 78 and the temperature measuring element 80 to the electrical device 25 and to the processing unit 26 of FIG. 1a respectively.

Moreover, a heat insulating element 90 is positioned within the cylindrical sheath of the portion 74 between the sensing components and the part of the cylindrical portion 74 in contact with the constriction 76.

More particularly, this heat insulating element 90 thermally insulates the sensing components from the remainder of the cylindrical portion 74 in order to avoid any heat dissipation along it.

The block 90 is thus in contact with the filling material 84.

The block 90 is, for example, a glass fiber adhesive block that is traversed by the connection means 86 and 88.

Moreover, the internal space of the front part 70a of the sensor that is placed behind the insulating block 90 is filled with a heat insulating material that ensures that the connection means are kept in place.

It is, for example, a material with proper temperature behavior of between −70° C. and +250° C. and is, for example, a silicone rubber.

This heat conductivity is, for example, 0.33 W/mK.

The sensors of the aforementioned embodiments can be used according to two operating methods.

A first method (first embodiment of the process according to the invention) consists in using square waves that are periodic in time such as are shown in FIGS. 3 and 4 (typically from 30 s to several minutes) in order to regularly heat the heating element and to have rest periods. Since the temperature is being continuously measured and provided by the unit 26, this temperature is the temperature of the fluid in a rest period (identified by T1 in FIGS. 3 and 4). In a heating period, this measured temperature is stabilized at the value T2 that is the skin temperature (or wall temperature) resulting from heat transfer from the heating element to the medium to be measured across the interface element (or directly when there is no interface element) and potentially across a fouling layer.

In the absence of fouling, the wall temperature (in the heating phase) is equal to the fluid temperature (within measurement errors and according to the heat resistance generated by the thickness of the interface element 20 when it is present) because the totality of the heat flow is dissipated into the measurement medium.

In the presence of fouling, an additional heat resistance opposes heat transfer toward the measurement medium, and the skin temperature (T2) assumes a value of greater than T1.

Thus, the fluid temperature (T1) and the skin temperature (T2) are duly known. To determine the thickness of the fouling, the aforementioned formulas and equations are applied so as to provide information to the display 27 (typically, the thickness of the fouling and the fluid temperature) and/or to the transmitter 28 in order to deliver a standardized signal (typically 4-20 mA) to be integrated into a monitor or a signal recorder.

Thus, advantageously, according to this method, the thickness of the fouling forming on the surface of the measuring device (sensor) is continuously evaluated in order to supply information to the user on the state of cleanliness as illustrated on the curve of FIG. 7.

This method does not require either preliminary calibration of the measurement device according to the conditions of use (flow rate or nature of the fluid) nor a posteriori processing of information to determine the thickness of fouling. On the other hand, variations of operating conditions (within a certain limit, such as the temperature, the flow rate, the pressure) do not influence the measurement of fouling (this imparts reliability to the method and allows continuous use and application in the industrial environments) since the device regularly recalculates the fluid temperature.

Finally, if the nature of the fouling that is forming is known a priori and its heat conduction is known a fortiori, then the system can supply a signal of the thickness of the fouling in μm or mm units; if not, the system bases itself on a default value of heat conduction from the fouling layer that can form, and the measurement signal is ultimately an indicator according to an arbitrary unit.

According to a second method (second embodiment of the process according to the invention), instead of using cycles of heating and no heating phases repeated indefinitely to know the temperature of the fluid (obtained in the no heating phase), heating can be constant under the condition of:
Either being in an application case in which the temperature does not vary, or does not vary when it is desired to take measurements, in which case the temperature is known and can be known from unit 26 (T1 is thus fixed),
Or the temperature is variable, but there are other means available for knowing this temperature (via a second temperature sensor already present, whose data reach the unit 26 or that can be easily derived by one skilled in the art in an existing device), in which case the temperature T1 is provided continuously.

The constant heating of the device allows information to be obtained more dynamically about the thickness of the fouling based on the difference T2−T1, or more or less real time information regarding the kinetics of formation and disappearance by treatment of fouling (typically less than 0.5 s).

Thus, this operating mode makes it possible to trace rapid phenomena of increase or decrease of fouling such as the tracking of cleaning phases in the agricultural industry, for example. This is thus useful for optimizing these cleaning phases (often long and always expensive), knowing that no real device (nor any global method) can track the efficiency of these cleanings in real time.

It should be noted that the first method could, however, be used to track the phases of cleaning in industries in which the time constraint is less critical.

FIG. 7 shows a curve of the progression of the thickness of fouling formed on the surface of a sensor according to the invention over time, such as that of FIGS. 2 and 6a-b, mounted on industrial cooling piping such as an air-cooled tower. The circulating fluid is water originating from the natural environment (river). The circuit has regular periods of chemical treatment. The only deposit that can form under these application conditions is of an organic nature (biofilm) whose coefficient of heat conductivity is roughly 0.6 W/m/K.

The material of the wall is stainless steel of type 316L, like the sensor interface element.

This curve was obtained after implementing the process according to the invention, namely the application of a series of periods of heating and no heating that led to measurements of representative temperature deviations of the deposition of fouling layers.

The system has operated for several months without interruption, producing continuously and on-line, measurements of organic fouling developing on the inner walls of the piping and on the surface of the sensor.

Regular visual observations, parallel with continuous measurements, have made it possible to show the correlation between the values provided by the system and the state of fouling of the piping.

The curve of FIG. 7 has an extract period representing essentially 40 days of operation during which several events, marked by the numbers 1 to 4 on the graph, appeared.

To facilitate the interpretation, the time axis has been recalibrated at the origin of the curve of the graph to the value 0. At the start of this period, the surface of the sensor is clean, just like the piping. The events 1, 2, and 3 correspond to the intake of new volumes of water that will enrich the existing circulating medium and thus again promote the growth of an organic fouling.

The curve actually shows kinetics of resumption of fouling toward the 7th, 12th and 18th day (events 1, 2, and 3 respectively). Visual inspections have confirmed the measurements.

Between the 18th and 35th day, the fouling deposit was stabilized around a value of roughly 1.6 mm.

The period of fluctuation observed between the 20th and 35th day corresponds to the pseudo-mature period of a mature biofilm, a period well known to one skilled in the art.

On the 35th day (event 4), a spot chemical treatment was done without interrupting the industrial process.

The sensor recorded a decrease of fouling without, nevertheless, returning to zero and a more or less immediate resumption of fouling.

All this has been confirmed by visual observations and samplings.

1-18. (canceled)

19. Sensor (10; 34) for measuring and/or detecting a fouling that forms on one surface of the sensor, characterized in that it comprises the following:
A substrate (22) that is used for heat insulation,
At least one heating element (16; 36; 58; 78) that is arranged on one side on the substrate that is able to diffuse, on command, a homogenous, monitored heat flow from the side opposite the substrate,
A single temperature measuring element (18; 38; 56; 80) with dimensions that are smaller than those of said at least one heating element and positioned above and at the center of the latter, on the side opposite the substrate, in order to be in the most homogeneous part of the heat flow.

20. Sensor according to claim 19, wherein the temperature measuring element is miniaturized relative to said at least one heating element.

21. Sensor according to claim 19, wherein the temperature measuring element has a surface whose size is at least essentially less than 100 times that of the surface of said at least one heating element.

22. Sensor according to claim 19, wherein said at least one heating element is able to generate a heat output density of between 1 and 4 mW/mm².

23. Sensor according to claim 19, wherein it comprises at least one heat conductive interface element (20; 54b) with two opposite surfaces, one of the surfaces, called inner surface, being arranged against the temperature measuring element, and the other surface, called outer surface, being designed to be in contact with the fluid.

24. Sensor according to claim 23, wherein said at least one interface element has a heat resistance that is less than or equal to 4° C./W.

25. Sensor according to claim 23, wherein said at least one interface element is made of stainless steel.

26. Sensor according to claim 19, wherein it has a general elongated shape in a longitudinal direction, with said at least one heating element (16; 58) and the temperature measuring element (18; 56) being aligned behind one another in the longitudinal direction of the sensor.

27. Sensor according to claim 19, wherein it has a general elongated shape in a longitudinal direction, with said at least one heating element (36; 78) and the temperature measuring element (38; 80) being aligned behind one another in a direction that is perpendicular to the longitudinal direction of the sensor.

28. System for measurement or detection of fouling formed on one surface of the sensor according to claim 19, which is exposed to a fluid, comprising the following:
Means for determining a temperature deviation between, on the one hand, the wall temperature measured by the temperature measuring element when said at least one heating element is diffusing a heat flow, and, on the other hand, the temperature of the fluid,
Means for calculating the thickness of the fouling formed on the surface of the sensor that is exposed to the fluid based on the determined temperature deviation.

29. Process for measuring and/or detecting the fouling that has formed on the sensor according to claim 19 when the latter is installed in one wall of a container containing a fluid and comprises one surface exposed to the fluid.

30. Process according to claim 29, wherein it comprises the following stages:
Determining a temperature deviation between, on the one hand, the wall temperature measured by the temperature measuring element when said at least one heating element is diffusing a heat flow, and, on the other hand, the temperature of the fluid,
Calculating the thickness of the fouling formed on the surface of the sensor exposed to the fluid based on the determined temperature deviation.

31. Method according to claim 30, wherein the determination of a temperature deviation comprises the following stages:
Alternation of the phases for control of the diffusion of a heat output by said at least one heating element and of the non-diffusion of a heat output,
Permanent measurement of the wall temperature by the temperature measuring element during each of the aforementioned phases,
Determination of a temperature deviation between the temperatures measured by the temperature measuring element.

32. Process according to claim 31, wherein said at least one heating element is controlled to diffuse a heat output density of between 1 and 4 mW/mm².

33. Process according to claim 31, wherein the stage for control of diffusion of a heat flow by said at least one heating element comprises a stage for generation of an output modulation signal from said at least one heating element.

34. Process according to claim 33, wherein the signal is alternating.

35. Process according to claim 34, wherein the alternating signal is steady-state.

36. Process according to claim 35, wherein the steady-state alternating signal is square waves.
